(19) United States
(12) Patent Application Publication
(10) Pub. No.: US 2026/0276052 A1
(43) Pub. Date: Sep. 17, 2026

(54) Dust Cap and Shaft Scraper for Dampers and Actuators

(71) Applicant: Suspension Direct Inc., Lake Elsinore, CA (US)

(72) Inventors: Daniel Worley, Lake Elsinore, CA (US); Clement Fiore, Corona, CA (US)

(73) Assignee: Suspension Direct Inc., Lake Elsinore, CA (US)

(21) Appl. No.: 19/561,010

(22) Filed: Mar. 9, 2026

Related U.S. Application Data
(60) Provisional application No. 63/770,901, filed on Mar. 12, 2025.

(51) Int. Cl. F16F 9/38; F16F 9/32; F16F 9/36

(52) U.S. Cl. CPC F16F 9/38; F16F 9/3271; F16F 9/362; F16F 2226/04; F16F 2230/0023; F16F 2230/02; F16F 2230/30

(57) ABSTRACT

A dust cap for use with a damper or actuator. The cap has a body with a center hole, a bottom surface forming an outer lip, a circular side wall extending away from the bottom surface, the side wall configured for insertion into the open end of the main body, an inner lip disposed along and extending from at least a portion of an outer surface of the side wall, the inner lip configured to secure the dust cap to an inner surface of the shock body through frictional resistance, a cavity formed by an inner surface of the side wall and an interior surface of the bottom surface, and at least one vent hole disposed along the side wall configured to permit fluid communication between an exterior environment and the cavity, wherein the dust cap is made from a single piece of material. A method of using the same.

### CROSS-REFERENCE TO RELATED APPLICATIONS

This U.S. Non-Provisional Patent Application claims priority to U.S. Provisional Patent Application No. 63/770,901, titled “DUST CAP AND SHAFT SCRAPER FOR SHOCK ABSORBERS,” filed Mar. 12, 2025, the contents of which are incorporated by reference herein in their entirety.

### BACKGROUND

In the automotive and motorized vehicle fields, pistons moving through fluid inside a sealed tube is common, typically in the form of shock absorbers and/or hydraulic cylinders. Shock absorbers are used to increase the comfort and control that a user has over their vehicle. Each shock absorber utilizes a dust cap to prevent dust and/or water from sliding down the shock shaft and damaging the dust seal and potentially contaminating the fluid contained therein. Hydraulic cylinders, commonly used on large machinery to actuate one or more parts of the machinery, face the same issue. However, the current dust caps for dampers have deficiencies.

The present invention is directed to an improved dust cap for dampers.

### SUMMARY

The present invention addresses this need. In a first embodiment, the present invention is directed to a cap for use with a movable shaft. Optionally, the cap is a dust cap for use with a shock absorber having a shock shaft. Optionally, the cap is a dust cap for use with a hydraulic cylinder.

The cap comprises a body having an opening configured to allow the shaft to pass through; a coupling feature for attaching the cap to a housing associated with the shaft; and a scraping feature integrated with the cap and positioned to remove debris or buildup from an outer surface of the shaft as it moves through the opening; wherein the cap is formed from a unitary piece of material. Optionally, the material is selected from plastic, metal, rubber, composite, or combinations thereof.

Optionally, the body of the cap is generally circular main body and the single center hole has a diameter that is larger than an outer diameter of the shaft.

Optionally, the cap further comprises a generally flat bottom surface forming an outer lip, the outer lip having a diameter greater than an internal diameter of the main body and configured to removably couple to an open end of the main body.

Optionally, the coupling feature comprises a side wall, which is optionally circular, extending away from the flat bottom surface, the side wall having a diameter less than the diameter of the outer lip and configured for insertion into the open end of the main body, and an inner lip disposed along and extending from at least a portion of an outer surface of the side wall, the inner lip configured to secure the dust cap to an inner surface of the main body through frictional resistance.

Optionally, a cavity formed by an inner surface of the side wall and an interior surface of the bottom surface.

Optionally, the cavity is concave or bowl-shaped.

Optionally, at least one vent hole disposed along the side wall, wherein the vent hole is configured to permit fluid communication between an exterior environment and the cavity which allows air, moisture, or material trapped between the dust cap and an outside surface of the shaft to escape to the exterior environment.

Optionally, a top surface of the dust cap has at least one recessed portion proximate the center hole, wherein the recessed portion is configured to scrape material from the outside surface of the shaft.

Optionally, a top surface of the dust cap has at least one recessed portion partially surrounding the center hole, wherein the recessed portion is configured to scrape material from the outside surface of the shaft.

Optionally, a top surface of the dust cap is flat and extends flat all the way to the center hole.

In a second embodiment, the present invention is directed to a method of installing the dust cap for a damper. The method comprises the steps of a) providing at least one damper having a main body and a shaft; and b) coupling the dust cap to the open end of the main body.

In a third embodiment, the present invention is directed to a method of scraping ice off a shaft. The method comprises the steps of: a) coupling the dust cap to the shock body of a damper; and b) sliding the shaft through the center hole of the dust cap to remove material from the outside surface of the shaft.

### DRAWINGS

These and other features, aspects and advantages of the present invention will become better understood with reference to the following description, appended claims, and accompanying drawings where:

FIG. 1 is a perspective view of a shock absorber having a dust cap having features of the present invention;

FIG. 2 is a bottom perspective view of the dust cap shown in FIG. 1;

FIG. 3 is a top perspective view of the dust cap of FIG. 2;

FIG. 4 is a first sectional view of the dust cap of FIG. 3, taken along line 4-4, wherein a top surface of the dust cap has a concave portion;

FIG. 5 is second sectional view of the cap of FIG. 3, taken along line 4-4, wherein a top surface of the dust cap has a flat portion;

FIG. 6 is an enlarged sectional view of a portion of the shock of FIG. 1, wherein ice buildup on the shaft of the shock is shown; and

FIGS. 7A and 7B are additional enlarged sectional views of a portion of the shock and dust cap of FIG. 6 taken along lines 7A-7A, wherein the dust cap is shown scraping ice off the shaft of the shock absorber.

### DESCRIPTION

As used herein, the following terms and variations thereof have the meanings given below, unless a different meaning is clearly intended by the context in which such term is used.

The terms “a,” “an,” and “the” and similar referents used herein are to be construed to cover both the singular and the plural unless their usage in context indicates otherwise.

As used in this disclosure, the term “comprise” and variations of the term, such as “comprising” and “comprises,” are not intended to exclude other additives, components, integers ingredients or steps.

All dimensions specified in this disclosure are by way of example only and are not intended to be limiting. Further, the proportions shown in these Figures are not necessarily to scale. As will be understood by those with skill in the art with reference to this disclosure, the actual dimensions and proportions of any system, any device or part of a device disclosed in this disclosure will be determined by its intended use.

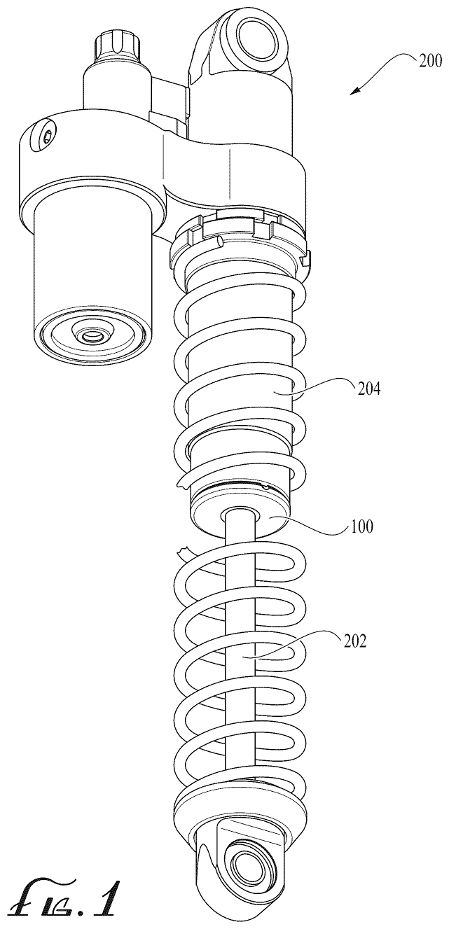

Referring now to FIG. 1, there is shown a dust cap 100 having features of the present invention. The dust cap 100 is configured for use on dampers 200. Dampers 200 can include but are not limited to shock absorbers and hydraulic cylinders. Each damper typically has a shaft 202 that slides into and out of a main body 204. The dust cap 100 surrounds the shaft 202 and prevents dust, dirt, water and other contaminants from sliding along the shaft 202 and into the main body 204.

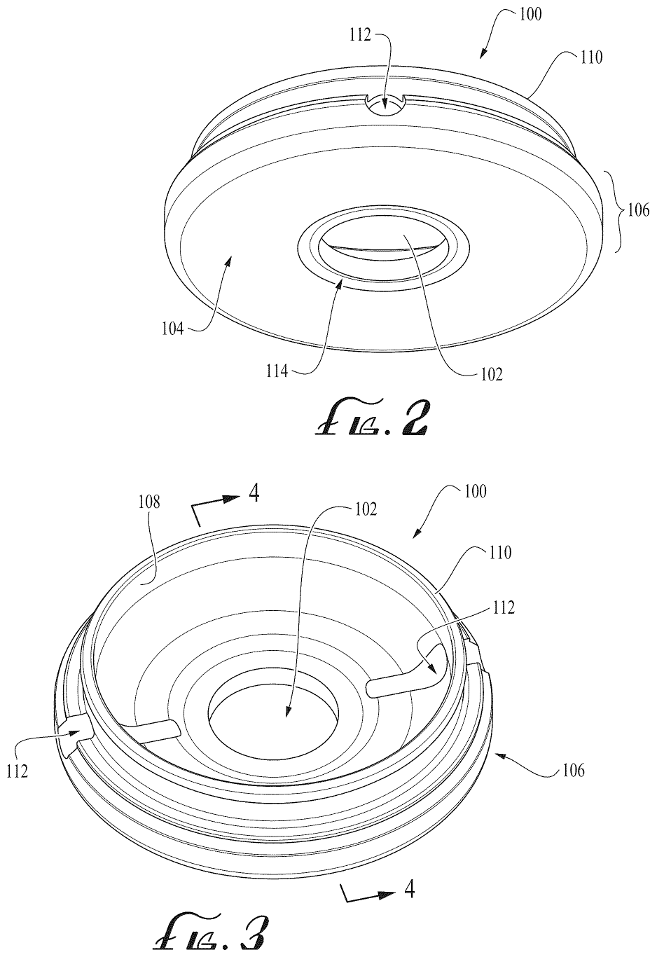

Referring now to FIGS. 2 and 3, there is shown the dust cap 100 in greater detail. The dust cap 100 is generally circular in shape and has a single center hole 102 disposed therein. The shock shaft 204 slides through this center hole 102. As such, the internal diameter of the center hole 102 should be only slightly larger than the outer diameter of the shock shaft 202 around which it will slide.

The dust cap 100 has a generally flat bottom surface 104 that is connected to and forms an outer lip 106. The outer lip 106 has a diameter that is greater than the diameter of the shock body 204 to which it is configured to removably couple. The outer lip 106 allows the dust cap 100 to seat against the open bottom of the shock body 204 and provide a tight seal. The removability of the dust cap 100 is preferred because through repeated use, dust caps in general can fail or wear out. Thus, being able to replace the dust caps 100 of the present invention is ideal.

The dust cap 100 has a circular side wall 108 that is coupled to and extends away from the flat bottom 104/outer lip 106, roughly perpendicular to the flat bottom 104/outer lip 106. The side wall 108 has an external diameter that is less than the outer diameter of the outer lip 106. The side wall 108 is configured for insertion into an open end of the shock body 204 to which it is being coupled. The side wall 108 can optionally include an inner lip 110 that extends from an outer surface of the side wall 108. The inner lip 110 can aid in securing the dust cap 100 to the shock body 204 through frictional resistance/application of pressure to the inside surface of the shock body 204. Optionally, the side wall 108 can be screwed into the shock body 204 or screwed into a seal case 205 of the shock body 204.

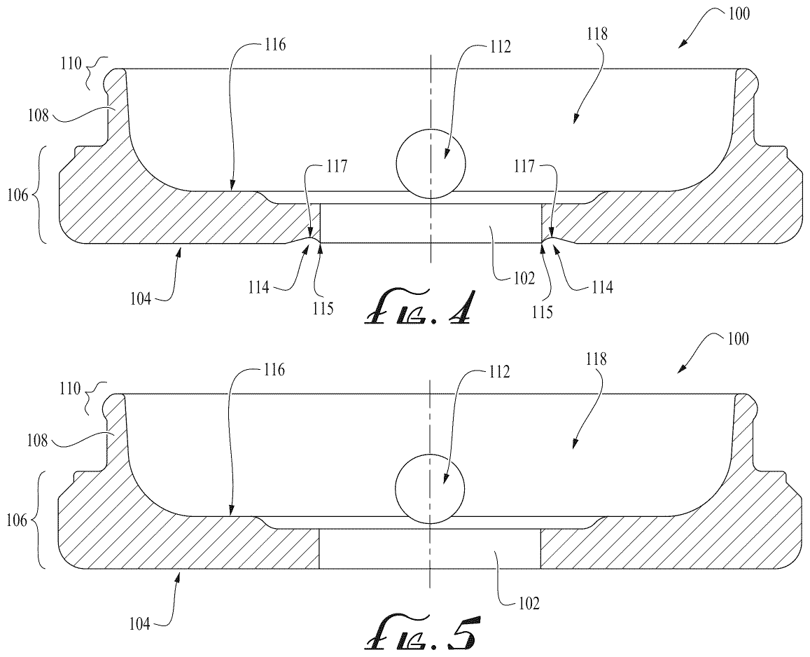

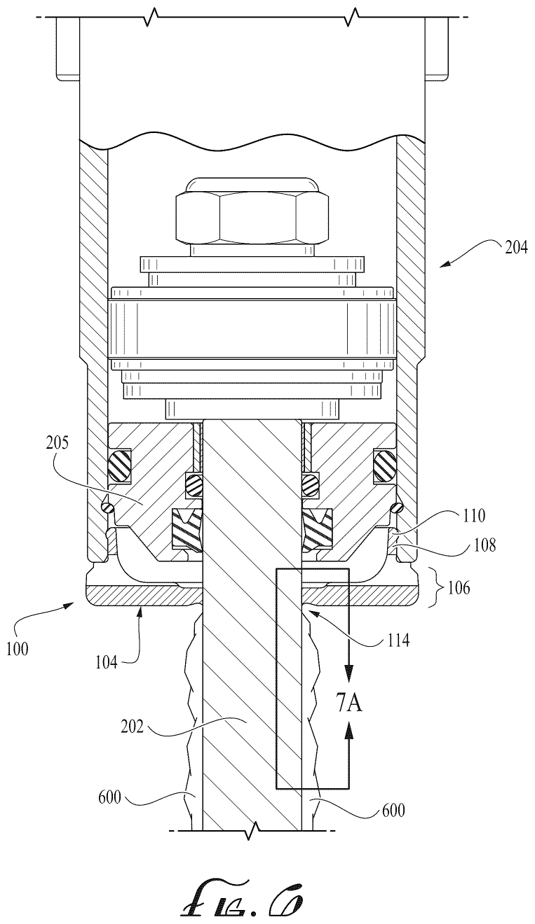

The side wall 108 and interior surface 116 of the bottom surface 104 create a cavity 118, visible in FIGS. 4 and 5. The cavity 118 may take any shape but can be generally concave or bowl-shaped, as illustrated in FIGS. 3-5.

Optionally, there is at least one vent hole 112 disposed along the side wall 108 of the dust cap 100. The vent hole(s) 112 allow fluid communication between an exterior environment of the dust cap 100 and the cavity 118, thereby permitting any air or moisture and/or material that is trapped between the dust cap 100 and the shock shaft 202 to escape to the exterior environment of the dust cap 100.

Referring now to FIGS. 4 and 5, the shape of the dust cap 100 is shown in more detail. FIG. 4 shows a preferred embodiment, wherein the top surface 104 of the dust cap 100 has at least one recessed portion 114 proximate the center hole 102. Preferably, recessed portion 114 as at least partially concave. More preferably, the concave portion 114 at least partially encircles the center hole 102. More preferably, the concave portion 114 completely encircles the center hole 102. Optionally, the dust cap 100 can comprise a plurality of concave portions 114 that are proximate the center hole 102 but are not actually connected to each other.

The recessed portion 114, typically illustrated as concave, may assume any configuration provided it is situated below at least a segment of the top surface 104, thereby establishing an innermost edge 115 along part of the circumference of the center opening 102. This edge 115 enables the cap 100 to move along the shaft 202, positioning itself beneath the ice 600 (or other contaminants that accumulate on the outer surface of the shaft 202) and subsequently remove or dislodge the ice 600 as it encounters the bottom surface 117 of the recessed portion 114.

This means that the design of the recessed portion 114 is not limited to a particular form; the recessed portion/area 114 could be rectangular, circular, polygonal, or even irregularly contoured in cross-section, depending on the specific requirements of the application. The primary condition is that its depth must fall below at least a portion of the surrounding top surface 104 of the cap 100 and form the innermost edge 115 along at least a portion of the inner circumference of the center opening 102. This flexibility in shape allows engineers and designers to accommodate various functionalities, such as fitting components, guiding movement, or providing structural support, without being constrained to a concave geometry. The recessed portion's 114 configuration can thus be optimized for aesthetic, ergonomic, or mechanical considerations, ensuring compatibility with different uses or manufacturing processes.

The recessed portion(s) 114 forms a scraper that scrapes material and/or debris, such as ice, dirt, mud or other contaminants, that have built up on the outer surface of the shock shaft 202, off the shock shaft 202. The dust cap 100 is specifically designed for shock absorber applications 200 operating in cold climates, including snowmobiles, bush aircraft, or other vehicles frequently exposed to wet, dirty, or low-temperature environments.

FIG. 5 shows a second embodiment, wherein the top surface 104 of the dust cap 100 does not have a recessed/concave portion 114 and instead remains flat and extends flat all the way to the center hole 102. The scraping function is still achieved, but it is not as efficient as if one or more recessed portions 114 were incorporated into the dust cap 100.

In both embodiments, the entire dust cap 100, including the top surface 104, the recessed portion 114 if the cap 100 has it, the outer lip 106, the side walls 108 and the inner lip 110 are all integrated with each other and are made from the same piece/a single piece of material (be it plastic, metal, rubber, composite or a combination of the same). This makes the dust cap 100 of the present invention less expensive to manufacture than known dust caps.

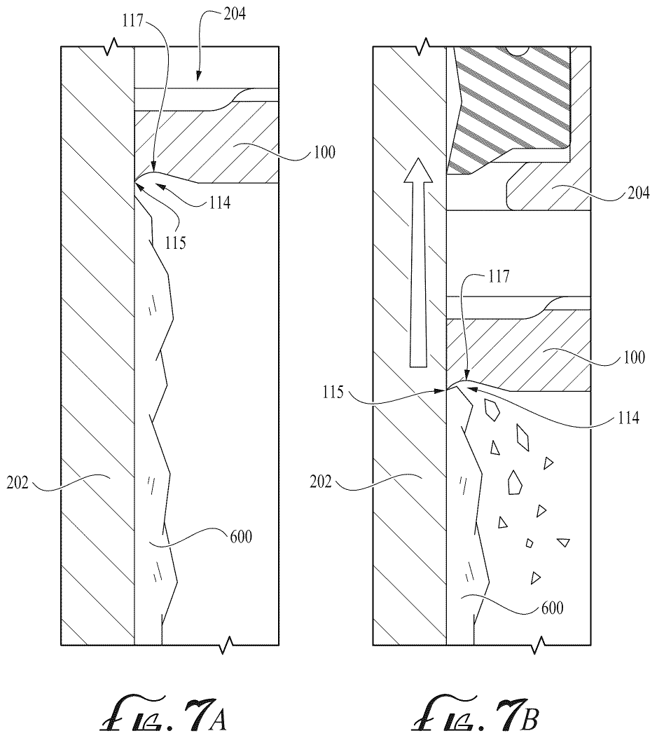

The ice scraping function can be best seen in FIGS. 6, 7A and 7B. FIG. 6 shows a typical shock absorber 200 with the dust cap 100 of FIG. 4 installed, and ice 600 that has built up on the outside surface of the shock shaft 202. The recessed/concave portion 114 of the dust cap 200 is crucial to efficiently performing the ice scraping function as it is able to catch and lift/chip away the ice 600 from the shaft 202.

A method of using and/or installing the dust cap 100 of the present invention comprises providing at least one shock absorber 200 and coupling a dust cap 100 to an open end of the shock body 204.

A method of scraping ice off at least one shock shaft 202 of a shock absorber 200 having a shock body 204, the method comprising the steps of coupling the dust cap 100 of the present invention to the open end of the shock body 204, and sliding the shock shaft 202 through the center hole 102 to remove ice from the shock shaft 202.

While the present invention is shown and discussed in detail with respect to shock absorbers, the present invention is not limited to use with shock absorbers and can be used with any sort of damper or actuator that utilizes a piston that moving through fluid inside a sealed tube.

Although the present invention has been described in considerable detail with reference to certain preferred embodiments, other embodiments are possible. The steps disclosed for the present methods, for example, are not intended to be limiting nor are they intended to indicate that each step is necessarily essential to the method, but instead are exemplary steps only. Therefore, the scope of the appended claims should not be limited to the description of preferred embodiments contained in this disclosure. All references cited herein are incorporated by reference.

What is claimed is:

1) A dust cap for use with a damper having a shaft, the dust cap comprising:
a) a generally circular main body having a single center hole configured to allow the shaft to slide therethrough, the center hole having a diameter that is larger than an outer diameter of the shaft;
b) a generally flat bottom surface forming an outer lip, the outer lip having a diameter greater than an internal diameter of the main body and configured to removably couple to an open end of the main body;
c) a circular side wall extending away from the flat bottom surface, the side wall having a diameter less than the diameter of the outer lip and configured for insertion into the open end of the main body;
d) an inner lip disposed along and extending from at least a portion of an outer surface of the side wall, the inner lip configured to secure the dust cap to an inner surface of the main body through frictional resistance;
e) a cavity formed by an inner surface of the side wall and an interior surface of the bottom surface; and
f) at least one vent hole disposed along the side wall, the vent hole configured to permit fluid communication between an exterior environment and the cavity to allow air, moisture, or material trapped between the dust cap and an outside surface of the shaft to escape to the exterior environment;
wherein the dust cap is made from a single piece of material selected from plastic, metal, rubber, composite, or combinations thereof.

2) The dust cap of claim 1, wherein a top surface of the dust cap has at least one recessed portion proximate the center hole, the recessed portion configured to scrape material from the outside surface of the shaft.

3) The dust cap of claim 1, wherein a top surface of the dust cap has at least one recessed portion partially surrounding the center hole, the recessed portion configured to scrape material from the outside surface of the shaft.

4) The dust cap of claim 1, wherein a top surface of the dust cap is flat and extends flat all the way to the center hole.

5) The dust cap of claim 1, wherein the cavity is concave or bowl-shaped.

6) The dust cap of claim 1, wherein the damper is a shock absorber.

7) The dust cap of claim 1, wherein the damper is a hydraulic cylinder.

8) A method of installing a dust cap for a damper, the method comprising the steps of:
a) providing at least one damper having a main body and a shaft; and
b) coupling the dust cap of claim 1 to the open end of the main body.

9) A method of scraping ice off a shaft, the method comprising the steps of:
a) coupling the dust cap of claim 2 to the main body of a damper; and
b) sliding the shock shaft through the center hole of the dust cap to remove material from the outside surface of the shaft.

10. The dust cap of claim 1, wherein the dust cap is configured to removably couple to the main body.

11. A cap for use with a movable shaft, comprising:
a) a body having an opening configured to allow the shaft to pass through;
b) a coupling feature for attaching the cap to a housing associated with the shaft; and
c) a scraping feature integrated with the cap and positioned to remove debris or buildup from an outer surface of the shaft as it moves through the opening;
wherein the cap is formed from a unitary piece of material.

12. The cap of claim 11, wherein the scraping feature comprises a portion proximate the opening that is configured to engage and remove debris, including but not limited to ice, dirt, or other contaminants, from the outer surface of the shaft.

13. The cap of claim 12, wherein the portion proximate the opening is recessed as compared to at least a portion of the top surface of the cap.

14. The cap of claim 11, wherein the coupling feature is configured to allow removable or permanent attachment of the cap to the housing.

15. The cap of claim 14, wherein the coupling feature comprises a side wall extending away from a bottom surface of the cap, and, an inner lip disposed along an outer surface of the side wall, the inner lip configured to secure the dust cap to the shock body through frictional resistance.

16. The cap of claim 11, further comprising at least one vent or passage configured to allow fluid or material trapped between the cap and the shaft to pass therethrough.

17. The dust cap of claim 11, wherein the damper is a shock absorber.

18. The dust cap of claim 11, wherein the damper is a hydraulic cylinder.

19. A method of maintaining a shaft in a housing, the method comprising the steps of:
a) providing the cap of claim 9;
b) attaching the cap to the housing; and
c) moving the shaft through the opening in the cap, whereby the scraping feature removes debris or buildup from the shaft.
